(19) United States
(12) Patent Application Publication
(10) Pub. No.: US 2019/0144327 A1
(43) Pub. Date: May 16, 2019

(54) TRANSPARENT ARTICLES AND METHODS OF MAKING TRANSPARENT ARTICLES

(71) Applicants: United Technologies Corporation, Hartford, CT (US); Sikorsky Aircraft Corporation, Stratford, CT (US)

(72) Inventor: John E. Holowczak, S. Windsor, CT (US)

(21) Appl. No.: 15/809,657

(22) Filed: Nov. 10, 2017

(51) Int. Cl. C03C 3/04; C03B 23/025; B64C 1/14; F41H 5/26

(52) U.S. Cl. CPC C03C 3/045; F41H 5/263; B64C 1/1484; C03B 23/0252

(57) ABSTRACT

A method of making a transparent article includes mixing an oxygen source, a nitrogen source, a magnesium source, a silicon source and a calcium source. The oxygen source, the nitrogen source, the magnesium source, the silicon source, and the calcium source are milled and heated to form a molten oxynitride glass modified by calcium and magnesium. The molten oxynitride glass modified by calcium and magnesium is then cooled to form a transparent body having ballistic resistance with a level of performance satisfying Level IV of National Institute of Justice Standard 0108.01. Transparent articles having transparent bodies formed from the oxynitride glass are also described.

### BACKGROUND OF THE INVENTION

### 1. Field of the Invention

The present disclosure relates to transparent articles, and more particularly to methods of making transparent articles such as impact resistant windows for aircraft.

### 2. Description of Related Art

Armor is commonly used in vehicles to provide protection against projectiles. In applications where transparency is desired, such as in windows, glass and ceramic materials are typically employed due to the strength, hardness, and the fracture toughness of such materials.

Glass materials can provide effective impact resistance to relatively light projectiles, particularly those projectiles which fall into the category of ball rounds. For impact resistance to large caliber projectiles it is generally necessary to thicken the glass armor structures—commonly to thicknesses of five centimeters and greater—based on the level of protection desired. Such thickness can be prohibitive in aircraft due to the associated weight. In addition, commonly used silicate glasses lack sufficient hardness to defeat armor piercing projectiles.

Ceramic materials, like sapphire and spinel, can provide greater impact resistance than glass materials for a given thickness and weight. This is due to greater strength, hardness and fracture toughness of certain ceramics in comparison to glass. For these same reasons, however, ceramics can be difficult to work into curved or complex shapes of size necessary for transparent articles in aircraft. Suitable ceramics, by nature of their manufacturing, typically requiring slow and/or prohibitively expensive grinding and polishing of all major faces.

Such conventional material and structures have generally been considered satisfactory for their intended purpose. However, there is still a need in the art for improved compositions for transparent armor structures. The present disclosure provides a solution for this need.

### SUMMARY OF THE INVENTION

A method of making a transparent article includes mixing an oxygen source, a nitrogen source, a magnesium source, a silicon source, and a calcium source. The oxygen source, nitrogen source, magnesium source, silicon source, and calcium source are then heated to form a molten oxynitride glass modified by calcium and magnesium. The molten oxynitride glass is thereafter cooled to form a transparent body having ballistic resistance such that armor piercing test ammunition having a bullet mass of 166 grains fired from a barrel having a 22 inch length and traveling at a velocity of about 2850 feet per second does not penetrate the transparent body when tested in compliance with Level IV of National Institute of Justice Standard 0108.01, September 1985

In certain embodiments, the magnesium source can exclude magnesium hydride. The magnesium source can also exclude magnesium oxide. The magnesium source can include magnesium nitride. The magnesium source can consist essentially of magnesium nitride. The magnesium source can include magnesium oxide. The magnesium source can consist essentially of magnesium oxide. The magnesium source can include both magnesium nitride and magnesium oxide. The magnesium source can consist essentially of magnesium nitride and magnesium oxide.

In accordance with certain embodiments, the nitrogen source can primarily include calcium nitride. The silicon source can be a supplemental nitrogen source, such as silicon nitride. The magnesium source can be a supplemental nitrogen source. Milling the sources can include ball or rod milling the sources. Milling the sources can include anhydrously milling the oxygen, nitrogen, magnesium and calcium sources. Heating the milled sources can include heating the sources in an unpressurized inert atmosphere. It is contemplated that the milled sources can be heated in a nitrogen atmosphere having a pressure of about 1 atmosphere.

It is contemplated that, in accordance with certain embodiments, the oxygen source, nitrogen source, magnesium source, silicon source, and calcium source are milled. Heating the article can include heating the article to between about 1600 and 1700 degrees Celsius. The re-heated article can be shaped by slumping the re-heated article over an arcuate surface of a mandrel. Re-heating the article can include re-heating the article to between about 800 and 1000 degrees Celsius.

A transparent article includes a transparent body formed from oxynitride glass. The oxynitride glass includes magnesium and calcium modifying the oxynitride glass. The transparent body has ballistic resistance such that armor piercing test ammunition having a bullet mass of 166 grains fired from a barrel having a 22 inch length and traveling at a velocity of about 2850 feet per second does not penetrate the transparent body when tested in compliance with Level IV of National Institute of Justice Standard 0108.01, September 1985

In certain embodiments, the oxynitride glass can include selected amounts of calcium, magnesium, silicon, oxygen, and nitrogen. The oxynitride glass can consist essentially of calcium, magnesium, silicon, oxygen, and nitrogen. The oxynitride glass can contain magnesium and calcium in an aggregated atomic percent between about 10 and about 55 atomic percent. The oxynitride glass can contain about 30 to 50 atomic percent oxygen, 10 to 30 atomic percent nitrogen, 10 to 30 atomic percent silicon, substantially none to 25 atomic percent magnesium, and 10 to 30 atomic percent calcium.

Preferably, the oxynitride glass can have about 30 to 50 atomic percent oxygen, 15 to 25 atomic percent nitrogen, 19 to 23 atomic percent silicon, 2 to 10 atomic percent magnesium, and 14 to 20 atomic percent calcium. Most preferably, the oxynitride glass can contain between about 36 to 39 atomic percent oxygen, 17 to 19 atomic percent nitrogen, about 21 atomic percent silicon, about 5.5 atomic percent magnesium, and about 17.5 atomic percent calcium.

In accordance with certain embodiments, the transparent body can have a strike face and an opposed backing face. Either or both of the strike face and the backing face can be an as-melted surface. Either or both the strike face and the backing face can be an unpolished surface. Either or both the strike face and the backing face can be polished.

It is contemplated that the transparent body can have a profile bounded by an arcuate segment. An as-melted surface can define at least a portion of the arcuate segment. An unpolished surface can define at least a portion of the arcuate segment. An unground, polished surface can define at least a portion of the arcuate segment. The profile can be bounded by unground and ground surface segments. The transparent body can be dimensioned as a window, a screen, a canopy, or a dome.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a cross-sectional view of an exemplary embodiment of a transparent article constructed in accordance with the present disclosure, showing a transparent body having a strike face and a backing face;

FIG. 2 is a schematic diagram of the modified oxynitride glass of FIG. 1, showing an oxynitride glass including magnesium and calcium forming the transparent body;

FIGS. 3-6 are cross-sectional views of embodiments of transparent articles, showing exemplary shapes and arrangements of transparent bodies forming the transparent articles, respectively;

FIG. 7 is a diagram of a mixing operation for a method of making the oxynitride glass of FIG. 1, showing a magnesium source being combined with other sources;

FIG. 8 is a table of alternative magnesium sources for the mixing operation of FIG. 7, showing sources containing magnesium hydride and excluding magnesium hydride; and

FIGS. 9-20 are schematic diagrams of operations for a method of making transparent articles, showing operations of the method according to an exemplary embodiment.

### DETAILED DESCRIPTION OF THE PREFERRED EMBODIMENTS

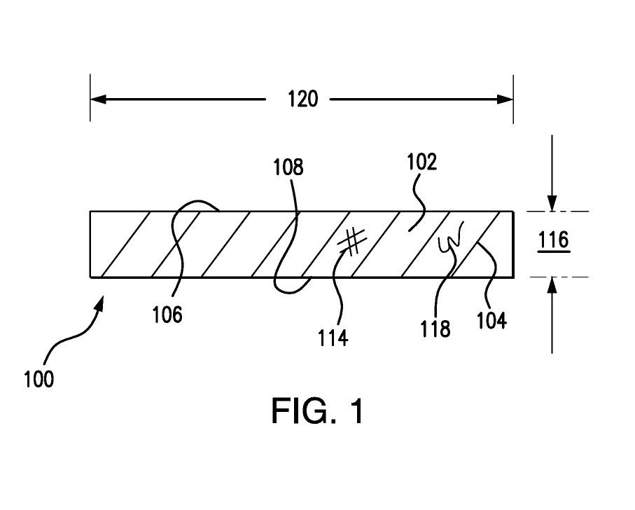

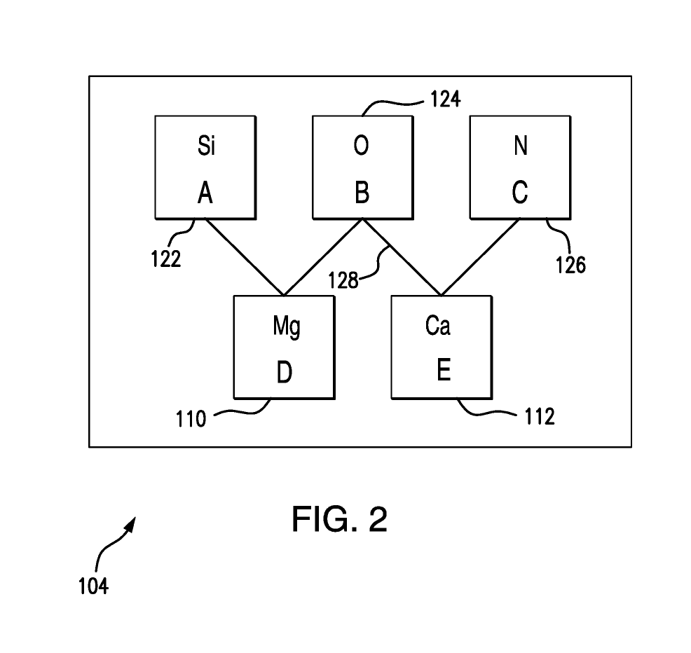

Reference will now be made to the drawings wherein like reference numerals identify similar structural features or aspects of the subject disclosure. For purposes of explanation and illustration, and not limitation, a partial view of an exemplary embodiment of a transparent article in accordance with the disclosure is shown in FIG. 1 and is designated generally by reference character 100. Other embodiments of transparent articles, transparent bodies included in transparent articles, and methods of making transparent articles in accordance with the disclosure, or aspects thereof, are provided in FIGS. 2-20, as will be described. The transparent articles, transparent bodies, and methods of making transparent articles described herein can be used for transparent armor in vehicles, such as in rotorcraft.

As used herein the term transparent armor means transmitting light without appreciable scattering in a manner such as ordinary window glass so that objects placed behind the transparent armor are clearly distinguishable. As also used herein the term “suitably sized” means having a monolithic size approximating that of an aircraft windscreen. As additionally used herein, the term “dimensioned” means having, as an unworked blank, length, width, and thickness approximate that of an aircraft windscreen. In certain embodiments the windscreen dimensioning is according to those of windscreens in Supplemental Type Certificate SR01340AT, issued by the FAA to Aeronautical Accessories Incorporated on Apr. 16, 1997, the contents of which is incorporated herein by reference in its entirety.

Referring to FIG. 1, transparent article 100 is shown. Transparent article 100 has a transparent body 102 formed from an oxynitride glass 104 with a strike face 106 and an opposed backing face 108. Oxynitride glass 104 is modified with magnesium 110 (shown in FIG. 2) and calcium 112 (shown in FIG. 2), transparent body 102 having ballistic resistance 114 such that armor piercing test ammunition having a bullet mass of 166 grains fired from a barrel having a 22 inch length and traveling at a velocity of about 2850 feet per second does not penetrate the transparent body when tested in compliance with Level IV of National Institute of Justice (NIJ) Standard 0108.01 dated September 1985, the contents of which are incorporated herein by reference in their entirety.

In certain embodiments, transparent article 100 has a thickness 116, weight 118, and dimensioning 120 which render transparent article suitable for use as transparent armor in a rotorcraft. For example, thickness 116 can be within a range of about 0.75 inches to about 1 inch. Weight 118 can be on the order of about 12 pounds to about 13 pounds. Dimensioning 120 can be such that transparent article 100 conforms to a conventional aircraft structure, such as a rotorcraft polycarbonate windscreen by way of non-limiting example. For example, in certain embodiments, transparent article 100 can have a surface area that is between about one (1) square foot and about 24 square feet. In accordance with certain embodiments, the surface of transparent article 100 can be planar.

It is contemplated that the surface of transparent article 100 can be curved or arcuate. Curvature of transparent article 100 can be simple or compound, as suitable for an intended application. Transparent article 100 can also be singular, i.e., comprising only one transparent body 102. It is also contemplated that transparent article 100 can be composite, i.e., comprising two or more transparent bodies stacked together. As will be appreciated by those of skill in the art, stacking transparent article 100 with one or more second transparent article 100 as a composite can provide increased impact protection.

With reference to FIG. 2, oxynitride glass 104 is shown. Oxynitride glass 104 has a lattice structure 128 including silicon 122 in an atomic percent of silicon A, oxygen 124 in an atomic percent of oxygen B, and nitrogen 126 in an atomic percent of nitrogen C. As will be appreciated by those of skill in the art in view of the present disclosure, the atomic percent nitrogen C influences the mechanical properties related to ballistic resistance of articles formed by oxynitride glass 104. As will also be appreciated by those of skill in the art in view of the present disclosure, increasing values of atomic percent nitrogen C relative to atomic percent silicon A and atomic percent oxygen B can increase the hardness and strength of transparent body 102 (shown in FIG. 1) significantly according to concentration, improving ballistic resistance of transparent body 102.

Lattice structure 128 also includes magnesium 110 in an atomic percent magnesium D and calcium 112 in an atomic percent calcium E. Cations of magnesium 110 and calcium 112 modify the network (i.e. lattice 128) otherwise formed by silicon 122, oxygen 124, and nitrogen 126. In this respect, magnesium 110 and calcium 112 distort lattice structure 128, modifying oxynitride glass 104 such that lattice structure 128 is less dense. In certain embodiments, oxynitride glass 104 is less dense without appreciable detriment of the mechanical properties of oxynitride glass 104 which influence ballistic resistance 114 (shown in FIG. 1) of transparent article 100. It is contemplated that atomic percent magnesium D and atomic percent magnesium E be selected to alter one or more of the mechanical properties of oxynitride glass 104 to increase ballistic resistance 114 (shown in FIG. 1) of transparent body 102 (shown in FIG. 1). Such modified oxynitride glasses can have favorable antiballistic properties, and in particular, favorable ballistic resistance properties. Accordingly, such articles can be used for transparent structures requiring ballistic resistance in aircraft, such as covers, windows, canopies, and domes. In rotorcraft, transparent articles formed as windscreens can provide ballistic resistance sufficient to withstand bird strikes at weights approximating that of polycarbonate structures of similar geometry. In certain embodiments oxynitride glass 104 can consist essentially of oxygen, nitrogen, silicon, magnesium and calcium.

Oxynitride glass 104 includes silicon 122 in a silicon amount A between about 10 to 30 atomic percent silicon. In certain embodiments, oxynitride glass 104 includes silicon 122 in a silicon amount A between about 19 to 23 atomic percent silicon. In an illustrative exemplary embodiment, oxynitride glass 104 includes silicon 122 in a silicon amount A that is about 21 atomic percent silicon.

Oxynitride glass 104 includes oxygen 124 in an oxygen amount B between about 30 to 50 atomic percent oxygen. In certain embodiments, oxynitride glass 104 includes oxygen 124 in an oxygen amount B between about 35 to 40 atomic percent oxygen. In an illustrative exemplary embodiment, oxynitride glass 104 includes oxygen 124 in an oxygen amount B between about 36 to 39 atomic percent oxygen.

Oxynitride glass 104 includes nitrogen 126 in a nitrogen amount C between about 10 to 30 atomic percent nitrogen. In certain embodiments, oxynitride glass 104 includes nitrogen 126 in a nitrogen amount C between about 15 to 25 atomic percent nitrogen. In the illustrative exemplary embodiment, oxynitride glass 104 includes nitrogen 126 in a nitrogen amount C between about 36 to 39 atomic percent nitrogen.

Oxynitride glass 104 includes substantially no magnesium, i.e. completely absent or in a trace amount, to a magnesium amount D of about 25 atomic percent magnesium. In certain embodiments, oxynitride glass 104 includes magnesium 110 in a magnesium amount D between about 2 to 10 atomic percent magnesium. In the illustrative exemplary embodiment, oxynitride glass 104 includes magnesium 110 in a magnesium amount D that is about is 5.5 atomic percent magnesium.

Oxynitride glass 104 includes calcium 112 in a calcium amount E between about 10 to 30 atomic percent calcium. In certain embodiments, oxynitride glass 104 includes calcium 112 in a calcium amount E between about 14 to 20 atomic percent calcium. In the illustrative exemplary embodiment, oxynitride glass 104 includes calcium 112 in a calcium amount E of about 15.5 atomic percent calcium.

Because of their size and light weight, magnesium cations 110 and calcium cations 112 reduce the density of oxynitride glass 104 as compared to unmodified oxynitride glass and oxynitride glass modified with rare earth elements. For that reason oxynitride glass 104 includes magnesium 110 and calcium 112 in a ratio that alters selected mechanical properties of modified oxynitride glass 104. For example, the ratio of magnesium 110 to calcium 112 can be selected to alter one or more of hardness, fracture toughness, strength, and/or density to influence ballistic resistance 114 (shown in FIG. 1) of transparent article 100 (shown in FIG. 1). The ratio of magnesium 110 to calcium 112 can be selected to alter flow and/or melt properties of modified oxynitride glass 104, rendering oxynitride glass 104 more readily formed into a transparent body with desired dimensioning 120, such as dimensioning suitable for an aircraft windscreen or window by way of non-limiting example. In certain embodiments the ratio of magnesium 110 to calcium 112 is selected such that, for a given density and thickness, transparent article 100 (shown in FIG. 1) has a greater ballistic resistance than an article with identical dimensioning with an aluminum-oxynitride composition.

In certain embodiments, oxynitride glass 104 can include between about 10 to 30 atomic percent silicon, 30 to 50 atomic percent oxygen, 10 to 30 atomic percent nitrogen, 10 to 30 atomic percent magnesium, and 10 to 30 atomic percent calcium. Preferably, oxynitride glass 104 includes between about 19 to 23 atomic percent silicon, 35 to 40 atomic percent oxygen, 15 to 25 atomic percent nitrogen, 2 to 10 atomic percent magnesium, and 14 to 20 atomic percent calcium. Most preferably, oxynitride glass 104 includes about 21 atomic percent silicon, 36 to 39 atomic percent oxygen, 17 to 19 atomic percent nitrogen, about 5.5 percent magnesium, and about 17.5 atomic percent calcium. Transparent articles, e.g., transparent article 100 (shown in FIG. 1), containing oxynitride glass 104 with compositions within these ranges can have transparency similar to that of polycarbonate, rendering transparent article 100 suitable for use as aircraft windscreens, domes, and windows. Such transparent articles can also have ballistic resistance such that armor piercing test ammunition having a bullet mass of 166 grains fired from a barrel having a 22 inch length and traveling at a velocity of about 2850 feet per second does not penetrate the transparent body when tested in compliance with Level IV of NIT Standard 0108.01 dated September 1985.

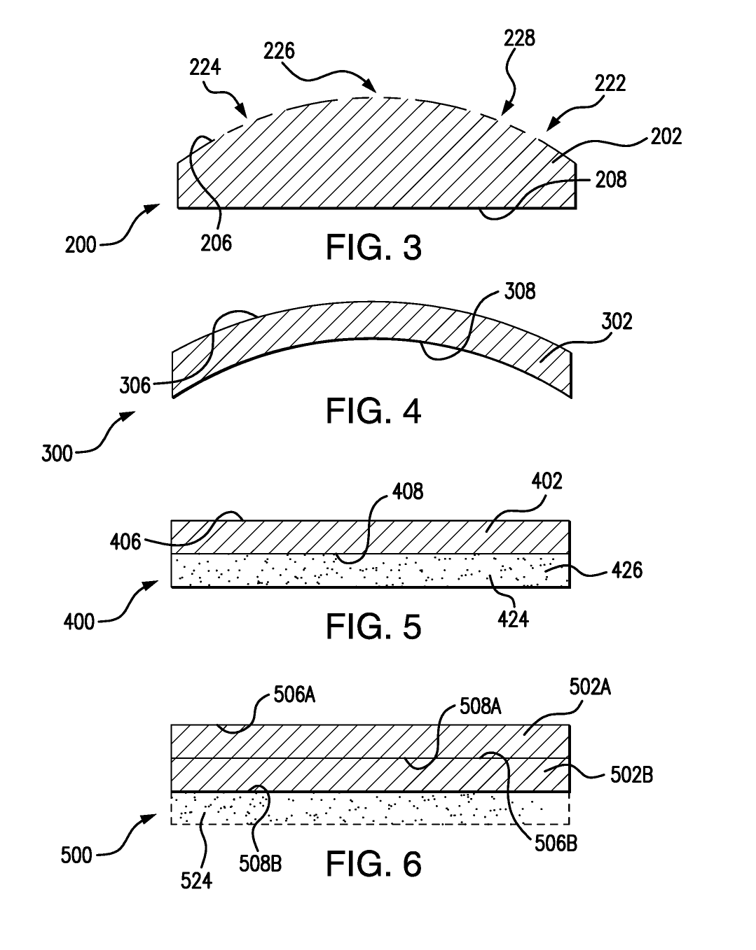

Referring now to FIGS. 3-6, transparent articles 200-500 are shown according to exemplary embodiments. With reference to FIG. 3, transparent article 200 is shown. Transparent article 200 is similar to transparent article 100 (shown in FIG. 1) and additionally includes a transparent body 202 with an arcuate surface 222. Arcuate surface 222 defines a curved strike face 206. A backing face 208 is defined on an opposite side of arcuate surface 222, backing face 208 being substantially planar in the illustrated exemplary embodiment. In certain embodiments either or both strike face 206 and backing face 208 include a ground portion 224. In accordance with certain embodiments, either or both strike face 206 and backing face 208 include a polished portion 226. It is also contemplated that either or both strike face 206 and backing face 208 can include an as-melted portion 228.

With reference to FIG. 4, transparent article 300 is shown. Transparent article 300 is similar to transparent article 100 (shown in FIG. 1) and additionally includes a transparent body 302 with an arcuate backing face 308. In the illustrated exemplary embodiment both a strike face 306 and backing face 308 of transparent body 302 have a curved (or arcuate) shape, transparent article 300 having an arcuate profile.

With reference to FIG. 5, transparent article 400 is shown. Transparent article 400 is similar to transparent article 100 (shown in FIG. 1) and additionally includes backing layer 424. Backing layer 424 is disposed over backing face 408 as a conformal layer. It is contemplated that backing layer 424 can include a containment material 426, such as polycarbonate, containment material 426 being arranged to limit spall from transparent body 402 upon projectile impact on strike face 406.

With reference to FIG. 6, transparent article 500 is shown. Transparent article 500 is similar to transparent article 100 (shown in FIG. 1) and additionally includes a plurality of transparent bodies, e.g., a first transparent body 502A and at least one second transparent body 502B in a stacked arrangement. A strike face 506B of second transparent body 502B is coupled to a backing face 508A of first transparent body 502A to increase ballistic resistance of transparent article 500. It is contemplated that transparent article 500 can include a backing layer 524 disposed over a backing face 508B of second transparent body 502, thereby providing spall containment upon projectile impact to strike face 506A.

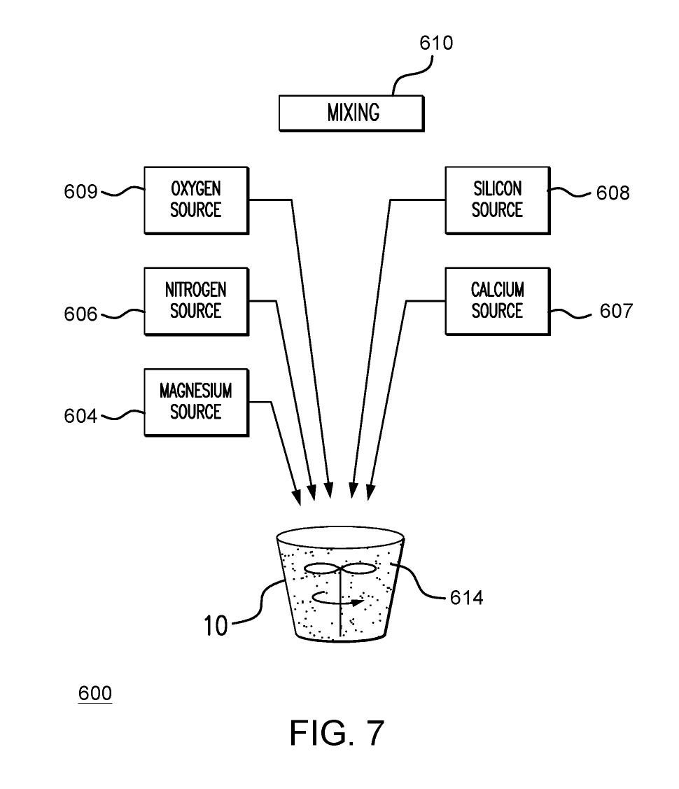

Referring to FIGS. 7-20, a method 600 of making a transparent article, e.g., transparent articles 100-500 (shown in FIGS. 1 and 3-6), is shown. As shown in FIG. 7, method 600 includes mixing 610 an oxygen source 609, a magnesium source 604, a nitrogen source 606, a silicon source 608, and a calcium source 607 to form a source mixture 614. Source mixture 614 can be blended in a blender apparatus 10, thereby uniformly distributing sources 604-609 within source mixture 614. It is contemplated that mixing sources 604-609 include mixing sources 604-609 in amounts that differ from the desired composition of oxynitride glass 104 (shown in FIG. 1) to account for partial evaporation of the respective atomic species during decomposition and melting of sources 604-609.

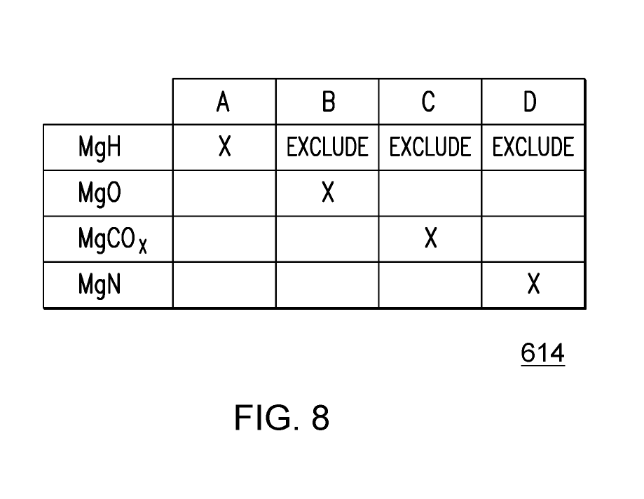

With reference to FIG. 8, alternative magnesium sources are shown for magnesium source 604. In this respect magnesium source 604 can include one or more of magnesium hydride (MgH), magnesium oxide (MgO), magnesium carbonate (MgCOₓ), and magnesium nitride (MgN), as shown in FIG. 8. For example, in certain embodiments, magnesium source 604 includes MgH, as shown in embodiment A. Embodiment A can be limited to MgH. Embodiment A can include MgH and one or more of MgO, MgCOₓ, and MgN.

As will be appreciated by those of skill in the art, while generally satisfactory as a source of magnesium, MgH is pyrophoric. Specifically, MgH liberates hydrogen during decomposition. The liberated hydrogen is extremely flammable, which can complicate the glass-making process, and in the case of oxynitride glasses, can make the fabrication of transparent bodies of suitable size and transparency for use as certain types of articles—such as transparent armor. For that reason magnesium source 604, in accordance with certain embodiments, excludes MgH.

For example, in an embodiment B, magnesium source 604 excludes MgH and includes MgO. MgO has the advantage that the oxygen generated from the decomposition of MgO is relatively inert compared to hydrogen, which simplifies the manufacture of oxynitride glass 104 (shown in FIG. 1) by reducing the pyrophoric behavior of decomposition products arising from magnesium source 604, allowing the manufacture of oxynitride glass in volume and transparency to form transparent articles suitable for aircraft structure. It is contemplated that magnesium source 604 can consist essentially of magnesium oxide. Alternatively, embodiment B can include MgCOₓ and/or MgN.

Alternatively, in an embodiment C, magnesium source 604 excludes MgH and includes MgCOₓ. MgCOₓ similarly has the advantage that the decomposition products generated from the decomposition of MgCOₓ are more inert than hydrogen and can include less oxygen than MgO, which simplifies the manufacture of oxynitride glass 104 (shown in FIG. 1) by reducing the pyrophoric behavior of decomposition products arising from magnesium source 604. As with embodiment B, embodiment C similarly allows for the manufacture of oxynitride glass in volume and transparency to form transparent articles suitable for aircraft structures. It is contemplated that magnesium source 604 can consist essentially of MgCOₓ. Alternatively, embodiment C can include MgO and/or MgN.

In a further embodiment D magnesium source 604 includes MgN. As with MgO and MgCOₓ, use of MgN has the advantage that the decomposition products arising from the decomposition of MgN, i.e., nitrogen, are inert. Accordingly, use of MgN as a source of magnesium simplifies the manufacture of oxynitride glass 104 (shown in FIG. 1) by eliminating entirely pyrophoric decomposition products from the magnesium source 604, allowing the manufacture of oxynitride glass in volume and transparency to form transparent articles suitable for aircraft structures. Moreover, the nitrogen arising from the decomposition of MgN can itself serve as a second nitrogen source 606, reducing the cost of making oxynitride glass articles. Further, MgN is readily available and relatively inexpensive, MgN being available in suitable purities as HP-30A, available from Pred Materials International, Inc. of New York, N.Y.

With continuing reference to FIG. 7, it is contemplated that nitrogen source 606 can include silicon nitride (SiN). SiN can be a primary nitrogen source and that calcium source 607 and/or magnesium source 604 can serve as secondary nitrogen sources in addition to serving as calcium source 607 and magnesium source 604, respectively. For example, calcium source 607 can include calcium nitride (CaN), CaN serving as a secondary source of nitrogen.

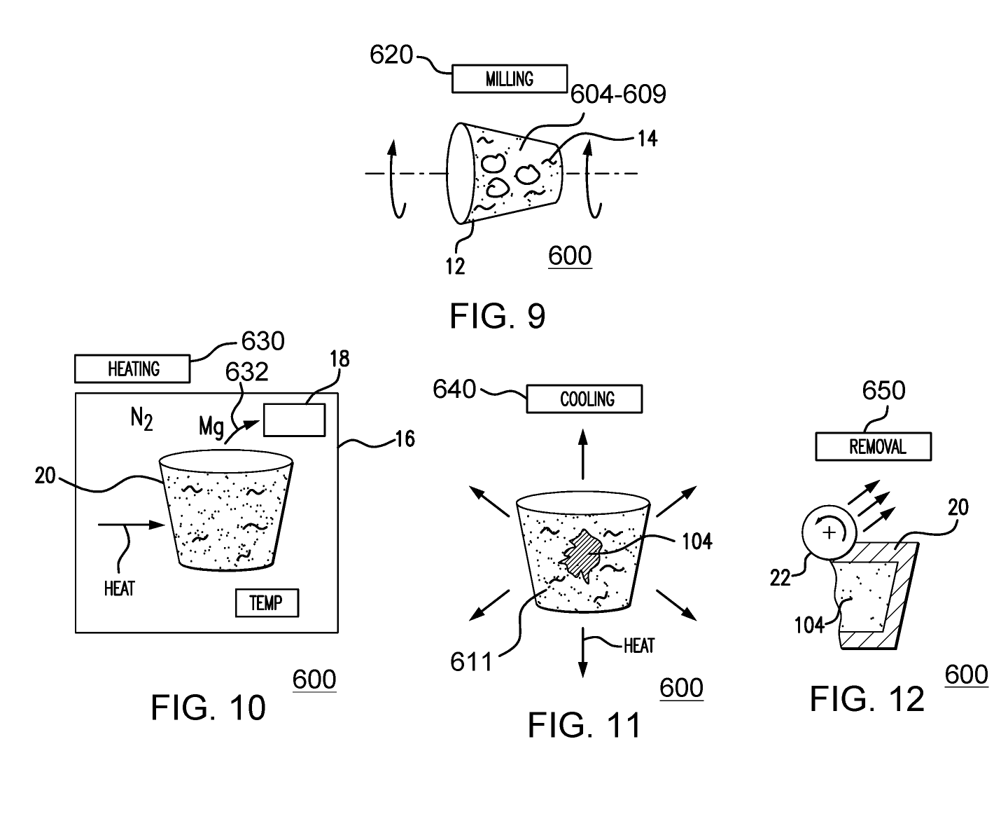

With reference to FIG. 9, once mixed together, sources 604-609 can be milled in a milling operation 620. Milling operation 620 includes introducing sources 604-609 into a milling apparatus 12. Milling apparatus 12 can be a ball or a rod milling apparatus, and milling operation 620 can be a ball or rod milling operation. Milling apparatus 12 can be a dry or a wet milling apparatus and milling operation 620 can include dry or wet milling sources 604-609. Wet milling can be done anhydrously, such as with a solvent 14 like hexane, in a polymer vessel. Wet milling can prevent the elemental oxides into oxynitride glass 104 (shown in FIG. 1), which could otherwise adversely affect the transparency of oxynitride glass 104. In an exemplary embodiment milling operation 620 includes wet milling sources 604-609 in a ball mill for between twelve hours and twenty four hours to obtain suitable uniformity and size.

With reference to FIG. 10, once milled, sources 604-609 are heated in a heating operation 630. Heating operation 630 includes introducing sources 604-609 into a furnace or oven 16. Furnace or over 16 is heated to a predetermined temperature and retained at the predetermined temperature such that sources 604-609 form a molten composition 611.

Heating operation 630 can include heating sources 604-609 in an inert atmosphere, such as a nitrogen atmosphere. Heating under an inert atmosphere can prevent the incorporation of contaminants into molten composition 611, such as elemental oxides. As will be appreciated by those of skill in the art in view of the present disclosure, reducing (or eliminating) contaminant incorporation allows transparent body 102 (shown in FIG. 1) to have transparency similar to that of window glass.

In accordance with certain embodiments, heating operation 630 can include heating sources 604-609 in an inert vessel 20, such as a niobium vessel. Inert vessel 20 can also reduce (or eliminate entirely) incorporation of contamination into molten composition 611. It is to be understood and appreciated that suitably inert vessels can also be constructed from tantalum, molybdenum and/or boron nitride, as suitable for a contemplated application.

In certain embodiments, heating operation 630 can include harvesting magnesium liberated from magnesium source 604 (shown in FIG. 7) and not incorporated in molten composition 611 in a magnesium collection operation 632. Magnesium collection operation 632 can include employment of a magnesium collection apparatus 18. As will be appreciated by those of skill in the art in view of the present disclosure, collecting magnesium can simplify method 600 as it eliminates the need to manage magnesium generated during the melting process and not incorporated into molten composition 611.

In certain embodiments heating operation 630 includes heating furnace 16 to a temperature between about 1550 and 1750 degrees Celsius for a predetermined time period. In accordance with certain embodiments heating operation 630 includes heating furnace 16 to a temperature between about 1625 and about 1725 degrees Celsius for predetermined time period. It is contemplated that heating operation 630 can include heating oxynitride glass 104 to a temperature of between about 1600 and 1700 degrees Celsius. In an exemplary illustrative embodiment heating operation 630 includes heating furnace 16 to about 1675 degrees Celsius for a predetermined time period of about two (2) hours. Due to the relative stability of magnesium nitride, embodiments utilizing magnesium nitride as a source of magnesium allow for heating at relatively low pressure, e.g., at around one (1) atmosphere, simplifying the heating operation.

With reference to FIG. 11, once heated, molten composition 611 is thereafter permitted to cool in a cooling operation 640. It is contemplated that cooling during cooling operation 640 occur rapidly, e.g., at a rate greater than 10 degrees Celsius/minute or faster, to prevent crystallization of oxynitride glass 104 (shown in FIG. 1). As will be appreciated by those of skill in the art in view of the present disclosure, rapid cooling allows solidification of oxynitride glass 104 into a transparent body, e.g., transparent body 102 (shown in FIG. 1). As will also be appreciated by those of skill in the art in view of the present disclosure, the resultant solidified transparent body 102 is formed substantially entirely of oxynitride glass 104 having a lattice 128 (shown in FIG. 2) of silicon, oxygen, and nitrogen modified with magnesium 110 (shown in FIG. 2) and calcium 112 (shown in FIG. 2) in the atomic weight percentages ranges described above.

With reference to FIG. 12, once cooled, oxynitride glass 104 is removed from vessel 20 in a removal operation 650. It is contemplated that removal operation 650 can be a destructive operation, for example by mechanically removing vessel 20 by grinding or milling away vessel 20 with a grinding wheel or milling tool 22. Alternatively, vessel 20 can be chemically removed, such as by dissolving vessel 20 using an acid with selectivity suitable for dissolving the material forming vessel 20.

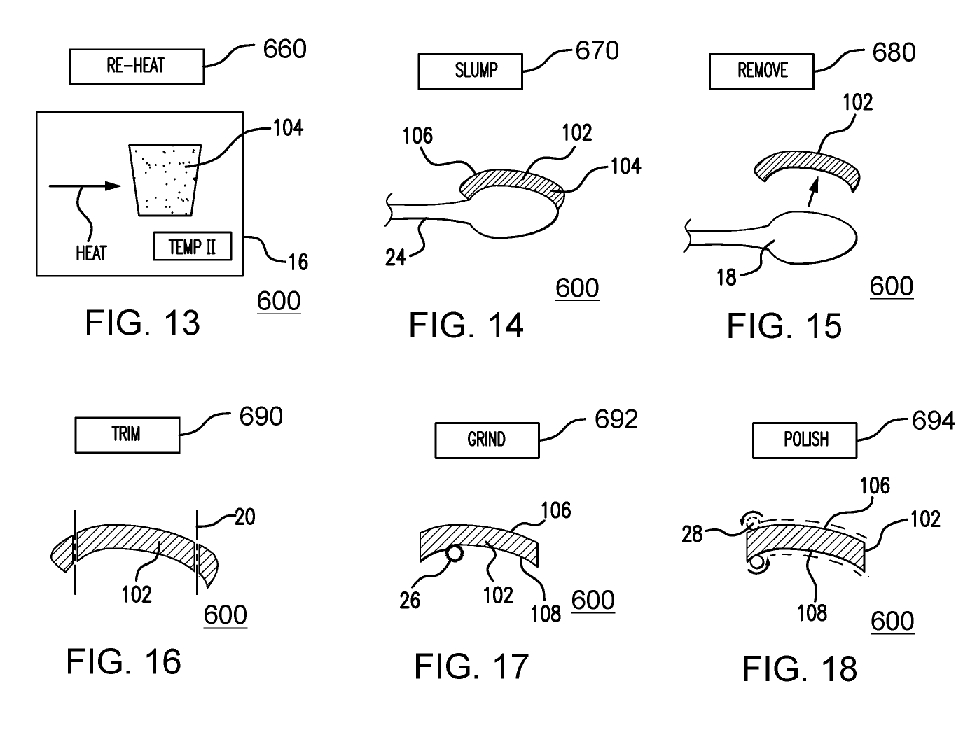

Referring to FIGS. 13-18, operations are shown for forming transparent body 102 from oxynitride glass 104. As shown in FIG. 13, oxynitride glass 104 is re-heated in furnace or oven 16 in a re-heat operation 660. It is contemplated that re-heat operation 660 include heating oxynitride glass 104 to a second predetermined temperature which is lower than the predetermined temperature employed in heating operation 630 (shown in FIG. 10). Re-heat operation 660 can include exposure to temperature of sufficient magnitude and duration to render oxynitride glass 102 workable, preferably via gravity. In certain embodiments the second predetermined temperature utilized for re-heat operation 660 is between about 1000 and 1100 degrees Celsius.

With reference to FIG. 14, once heated, oxynitride glass 102 is slumped over a mandrel 24 in slumping or shaping operation 670. Being relatively soft as a result of re-heat operation 660 (shown in FIG. 13), oxynitride glass 104 conforms to the contour of mandrel 24. The softness of oxynitride glass 104 allows gravity to slump oxynitride glass 104 over the surface of mandrel 24, the surface of oxynitride glass 104 thereby adopting the contour of the surface of mandrel 24 once cooled. The surface of mandrel 24 can be planar or curved, as suitable for an intended application, to define shape or profile of transparent body 102. Once sufficiently cool, transparent body 102 is removed from the surface of mandrel 24 is a removal operation 680, as shown in FIG. 15.

With reference to FIG. 16, transparent body 102 can be trimmed in an optional trimming operation 690. Either (or both) of strike surface 106 and backing surface 108 can be contoured in a grinding or milling operation 692 with a grinding or milling tool 26, as shown in FIG. 17.

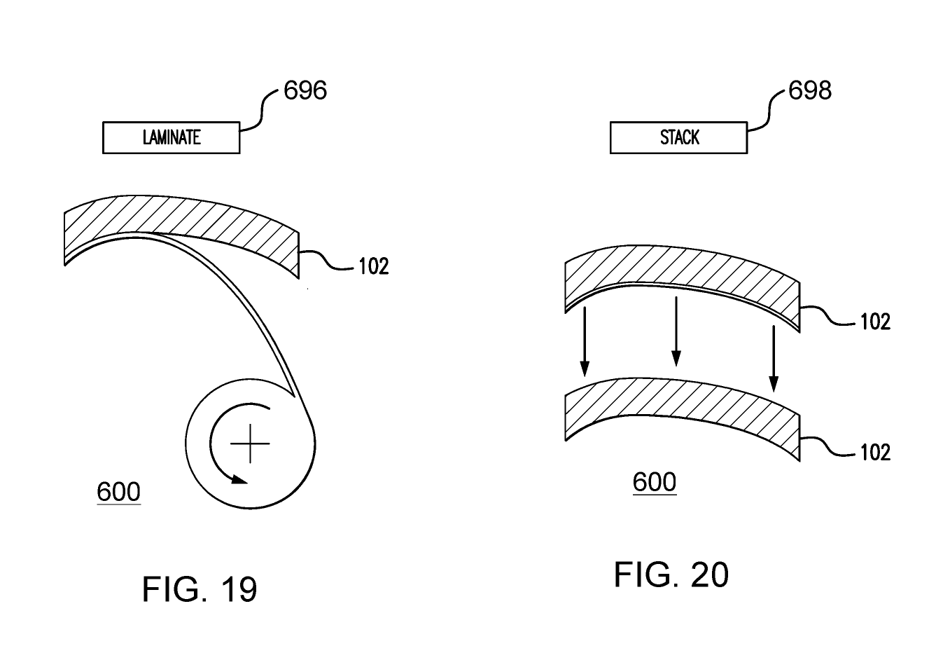

With reference to FIG. 18, either (or both) strike surface 106 and backing surface 108 can be contoured in an optional polishing operation 694. Polishing operation 694 can include the use of a polishing tool 28 to improve transparency of transparent body 102. As will be appreciated by those of skill in the art in view of the present disclosure, in accordance with certain embodiments grinding or milling operation 692 (shown in FIG. 17) and/or polishing operation 694 may only be necessary on a single side of transparent body 102, e.g., on the surface where transparent body 102 contacted the surface of mandrel 24 (shown in FIG. 14) during slumping operation 670, simplifying manufacture of transparent body 102. As shown in FIGS. 19 and 20, transparent body 102 can additionally be laminated with a laminate in an optional laminating operation 696 (shown in FIG. 19) and/or stacked with another transparent body 102 in a stacking operation 698 (shown in FIG. 20), thereby improving ballistic resistance of transparent article 100.

Transparent ceramic armor materials with hardness sufficient to defeat armor piercing projectiles have traditionally been limited to materials like spinel and sapphire. While satisfactory for their intended purpose such materials are relatively expensive and difficult to form into structures suitable for armor, such as for aircraft windscreens, covers, and windows.

In embodiments described, oxynitride glass modified with magnesium and calcium are disclosed. While of suitable hardness and density for use as armor, structures of suitable transparency, size, and dimensions have not been available due to the difficulty in manufacturing structures formed from oxynitride glass. Applicant has found that oxynitride structures of suitable transparency, dimensions, and size can be obtained through the selection of the oxynitride glass constituent sources. In this respect, Applicant has demonstrated the ability to fabricate high-hardness oxynitride glass with transparency, size, and dimensions through the use of magnesium and calcium hydride materials, mixed with silicon dioxide, and heated within a nitrogen atmosphere can provide network modifying nitrides (CaN and MgN) that avoid the challenges of adding nitrogen via silicon nitride, which tends to opacify the glass. Applicant has also found that the provision of magnesium to the glass development process through a high surface area provided synthetic magnesium silicate can simplify the fabrication process, through reduction (or elimination entirely) of elemental hydrogen during the glass-making process, and that oxynitride structures of suitable transparency, size and dimension for transparent armor can be formed.

In certain embodiments, the oxynitride glass modified with calcium and magnesium is amenable to re-heating to semi-molten state from the glass material and can be shaped (e.g., curved), reducing the amount of diamond grinding required to produce structures with similar shape formed from materials with high hardness (e.g., spinel, sapphire, etc.). In accordance with certain embodiments the glass materials have relatively few (if any) grain boundaries, reducing the variation in mechanical properties otherwise associated with the grain boundaries present in other high hardness glass materials, e.g., spinel and aluminum oxynitride materials. It is also contemplated that the glass material can be formed using a less volatile, low cost, and readily available synthetic magnesium silicate, simplifying fabrication of transparent article from the modified oxynitride glass constituent element sources.

The methods and systems of the present disclosure, as described above and shown in the drawings, provide for transparent articles with superior properties including transparency, size, and dimensioning suitable for use as transparent armor on aircraft. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of making a transparent article, comprising:
mixing an oxygen source, a nitrogen source, a magnesium source, a silicon source and a calcium source;
heating the oxygen source, the nitrogen source, the magnesium source, the silicon source, and the calcium source to form a molten oxynitride glass modified by calcium and magnesium; and
cooling the molten oxynitride glass modified by calcium and magnesium to solidify the molten oxynitride glass as a transparent body,
wherein the transparent body has ballistic resistance such that armor piercing test ammunition having a bullet mass of 166 grains fired from a barrel having a 22 inch length and traveling at a velocity of about 2850 feet per second does not penetrate the transparent body when tested in compliance with Level IV of National Institute of Justice Standard 0108.01, September 1985

2. The method as recited in claim 1, wherein the nitrogen source is silicon dioxide, wherein the calcium source is a second nitrogen source, and wherein the magnesium source is a third nitrogen source.

3. The method as recited in claim 1, wherein the magnesium source includes magnesium nitride.

4. The method as recited in claim 1, wherein the magnesium source includes magnesium oxide.

5. The method as recited in claim 4, wherein the magnesium source excludes magnesium hydride.

6. The method as recited in claim 4, wherein the magnesium source includes at least one of magnesium nitride, magnesium oxide, magnesium silicate, and magnesium carbonate.

7. The method as recited in claim 1, wherein the magnesium source consists essentially of magnesium nitride.

8. The method as recited in claim 1, wherein the magnesium source consists essentially of magnesium oxide.

9. The method as recited in claim 1, wherein the magnesium source consists essentially of magnesium nitride and magnesium oxide.

10. The method as recited in claim 1, wherein the magnesium source includes magnesium silicate.

11. The method as recited in claim 1, wherein the magnesium source consists essentially of magnesium silicate.

12. The method as recited in claim 1, further comprising milling the oxygen source, the nitrogen source, the magnesium source, the silicon source, and the calcium source.

13. The method as recited in claim 12, wherein milling includes anhydrously milling the oxygen, nitrogen, magnesium and calcium sources, wherein heating the milled oxygen, nitrogen, magnesium and calcium sources includes heating the sources in a nitrogen atmosphere with a pressure of less than 1 atmosphere.

14. The method as recited in claim 1, further comprising:
reheating the transparent body; and
dimensioning the re-heated transparent body by slumping the re-heated transparent body over an arcuate contour of a mandrel.

15. The method as recited in claim 1, wherein heating includes heating the transparent body to between about 1600 and 1700 degrees Celsius, wherein re-heating includes re-heating the transparent body to between about 600 and 1000 degrees Celsius.

16. A transparent article, comprising:
a transparent body including oxynitride glass; and
magnesium and calcium modifying the oxynitride glass, wherein the transparent body has a ballistic resistance such that armor piercing test ammunition having a bullet mass of 166 grains fired from a barrel having a 22 inch length and traveling at a velocity of about 2850 feet per second does not penetrate the transparent body when tested in compliance with Level IV of National Institute of Justice Standard 0108.01, September 1985.

17. The transparent article as recited in claim 16, wherein the transparent body has dimensioning approximating that of an aircraft windscreen.

18. The transparent article as recited in claim 16, wherein the oxynitride glass excludes aluminum.

19. The transparent article as recited in claim 16, wherein the oxynitride glass comprises oxygen, nitrogen, magnesium, silicon, and calcium.

20. The transparent article as recited in claim 16, wherein the oxynitride glass consists essentially of oxygen, nitrogen, magnesium, silicon, and calcium.

21. The transparent article as recited in claim 16, wherein the oxynitride glass has between about 30 to 50 atomic percent oxygen.

22. The transparent article as recited in claim 16, wherein the oxynitride glass has between about 10 to 30 atomic percent nitrogen.

23. The transparent article as recited in claim 16, wherein the oxynitride glass has between about 10 to 30 atomic percent silicon.

24. The transparent article as recited in claim 16, wherein the oxynitride glass comprises substantially none to about 25 atomic percent magnesium and between about 10 to 30 atomic percent calcium.

25. The transparent article as recited in claim 16, wherein the oxynitride glass comprises between about 30 to 50 atomic percent oxygen, 10 to 30 atomic percent nitrogen, 10 to 30 atomic percent silicon, substantially none to 25 atomic percent magnesium, and 10 to 30 atomic percent calcium.

26. The transparent article as recited in claim 16, wherein the oxynitride glass comprises between about 35 to 40 atomic percent oxygen, 15 to 25 atomic percent nitrogen, 19 to 23 atomic percent silicon, 2 to 10 atomic percent magnesium, and 14 to 20 atomic percent calcium.

27. The transparent article as recited in claim 16, wherein the oxynitride glass comprises between about 36 to 39 atomic percent oxygen, 17 to 19 atomic percent nitrogen, about 21 atomic percent silicon, about 5.5 atomic percent magnesium, and about 17.5 atomic percent calcium.

28. The transparent article as recited in claim 16, wherein the transparent body has strike and opposite backing faces, one of the strike and backing faces being an as-melted surface.

29. The transparent article as recited in claim 16, wherein the transparent body has a profile with an arcuate segment, wherein the as-melted surface defines the arcuate segment of the profile.

30. The transparent article as recited in claim 16, wherein the transparent body has a strike face and an opposed backing face, at least one of the strike and backing faces being an as-melted surface.

31. The transparent article as recited in claim 30, wherein the transparent body has a profile with an arcuate segment, wherein the unpolished surface defines the arcuate segment of the profile.

32. The transparent article as recited in claim 16, wherein the transparent body has a profile with an arcuate segment, wherein the profile is bounded by an as-melted surface segment and a ground surface segment.

33. The transparent article of claim 16, wherein the transparent body is has dimensioning corresponding to that of a window, a screen, a canopy, or a dome.

34. An armor window for an aircraft, comprising:
a transparent article as recited in claim 16,
wherein the oxynitride glass comprises between about 36 and about 39 atomic percent oxygen, between about 17 and about 19 atomic percent nitrogen, about 21 atomic percent silicon, about 5.5 atomic percent magnesium, and about 17.5 atomic percent calcium,
wherein the transparent body has a strike face and an opposed backing face, wherein the strike face has an arcuate profile and an as-melted surface in a finished state, wherein the backing face has an arcuate profile that is ground or polished in the finished state.
